(19) United States
(12) Patent Application Publication
(10) Pub. No.: US 2005/0112327 A1
(43) Pub. Date: May 26, 2005

(54) Removable flexible panel

(76) Inventor: Ray Skaggs, Tulsa, OK (US)

Correspondence Address: BRENT A. CAPEHART;LaRiviere, Grubman & Payne, LLP, 19 Upper Ragsdale Drive, Suite 200, P.O Box 3140, Monterey, CA, 93940, US

(21) Appl. No.: 10/720,418

(22) Filed: Nov. 24, 2003

(51) Int. Cl. B32B 3/00

(52) U.S. Cl. 428/156

(57) ABSTRACT

The present invention provides a panel which may be removably inserted into a nonrigid container, which container is comprised of at least one container wall defining a container opening. The panel is characterized at least in that it is formed from a flexible material having a memory of its original shape such that it can be coiled and returned to its original shape upon release. Preferably, the device is rectangular and includes a series of memory retention units therein. Among the advantages provided by the device is that it may be repeatedly coiled and inserted into a nonrigid container so that, upon release, the container may be retained in an upright and open position for easy access, all without breaking or cracking and without damaging the container either during retention of the container or during its removal therefrom.

### REFERENCE TO PENDING APPLICATIONS

This application is not referenced in any pending applications.

### REFERENCE TO MICROFICHE APPENDIX

This application is not referenced in any microfiche appendix.

### BACKGROUND OF THE INVENTION

1. Field of the Invention

The present invention generally relates to boards or panels which are sized and configured to hold a nonrigid container in an open and upright position.

2. Background

Flexible bags and other nonrigid containers are used to hold a great variety of items, many of which are not rigid. It is frequently desirable to support a flexible bag which is in the process of being filled, so that the individual filling the bag may use both hands. The lack of rigidity in such containers can create difficultly in the loading of these containers, especially when a single user is attempting to do so.

One example of a flexible bag is the lawn trash bag. These bags are typically made of plastic, and may have a capacity of approximately thirty to sixty gallons. Lawn trash bags are generally filled with leaves, sticks, dead plants, and other trash associated with gardening. One problem associated with their use is the difficulty of filling them. If only one person is available, he must generally attempt to hold the lawn trash bag open with one hand, while inserting the intended contents with the other. This can be an awkward and time-consuming process.

Solutions are known which represent others attempts to address this problem. For example, U.S. Pat. No. 4,749,011 to Rylander discloses a flat planar body which may be rolled into a cylindrical shape and inserted into a flexible container and released therein to stretch the wall of the container and hold the container in an open and upright position. This device and other similar prior art devices do not have sufficient flexibility to return to its original shape, i.e. a flat planar body. Instead, these devices have a tendency to curl and assume a quasi-cylindrical shape. This causes the device to loss in its effectiveness at expanding to stretch the wall of the container. Thus, while Rylander and other similar devices contribute to the art, these known devices still suffer from their failure to adequately combine flexibility with the ability to retain memory of their original shape.

Accordingly, a need still exists for a panel which has sufficient rigidity and shape memory to repeatedly open and retain a flexible container open when disposed therein while also being sufficiently flexible and otherwise configured to be easily removed from, and to avoid damage to, the container with which it is used.

### BRIEF SUMMARY OF THE INVENTION

The present invention satisfies the needs discussed above. The present invention is generally directed toward a storage and shipping container, more specifically toward a storage and shipping container that allows for access into the container in an efficient and safe manner.

As used herein, the term container refers to all plastic bags and other nonrigid containers which have a single opening through which items are placed into the space defined by the container.

In one aspect, the present invention provides a panel which may be removably inserted into a container. The panel is formed from a flexible material having a memory of its original shape such that it can be coiled and returned to its original shape upon release. Preferably, the device is rectangular and includes a series of memory retention units therein. Among the advantages provided by the device is that it may be repeatedly coiled and inserted into a container so that, upon release, the container may be retained in an upright and open position for easy access, all without breaking or cracking and without damaging the container either during retention of the container or during its removal therefrom.

By having a panel being formed from a combination of flexible material and a series of memory retention units, the present invention is capable of be sufficiently flexible to be repeatedly coiled into a substantially cylindrical configuration while having sufficient elasticity to return to its initial substantially flat configuration.

The panel can be made from various polymer or rubber compounds having characteristics sufficient to allow the panel to be flexible yet retain original shape characteristics. To assist the panel in returning to its original substantially flat shape, the memory retention units are imbedded in the polymer compound. These memory retention units can be made from a variety of materials such as but not limited to spring steel.

In another aspect of the present invention, the memory retention units are a plurality of longitudinal strips positioned at various locations within the panel. These longitudinal strips provide additional memory retention to the panel, and in turn, allow the panel to return to its original flat configuration after repeated coiling.

Upon reading the above description, various alternative embodiments will become obvious to those skilled in the art. These embodiments are to be considered within the scope and spirit of the subject invention, which is only to be limited by the claims which follow and their equivalents.

Further objects, features and advantages of the present invention will be apparent to those skilled in the art upon reference to the accompanying drawings and upon reading the following description of the preferred embodiments.

### BRIEF DESCRIPTION OF THE DRAWINGS

FIG. 1 is a front perspective view an embodiment of the present invention.

FIG. 2 is a side view of an embodiment of the present invention as shown if FIG. 1 along line 2-2.

FIG. 3 is a side view of an embodiment of the present invention as shown if FIG. 1 along line 3-3.

FIG. 4 is a side view of an additional embodiment of the present invention.

FIG. 5 is a perspective view of an embodiment of the present invention is a partially coiled configuration.

FIG. 6 is a perspective view of an embodiment of the present invention inserted into a flexible container.

FIG. 7 is a perspective view of an embodiment of the present invention is a partially coiled configuration.

### DETAILED DESCRIPTION OF THE PREFERRED EMBODIMENTS

Before explaining the present invention in detail, it is to be understood that the invention is not limited in its application to the details of the construction and arrangement of parts illustrated in the accompanying drawings. The invention is capable of other embodiments and of being practiced or carried out in a variety of ways. It is to be understood that the phraseology and terminology employed herein are for the purpose of description and not of limitation.

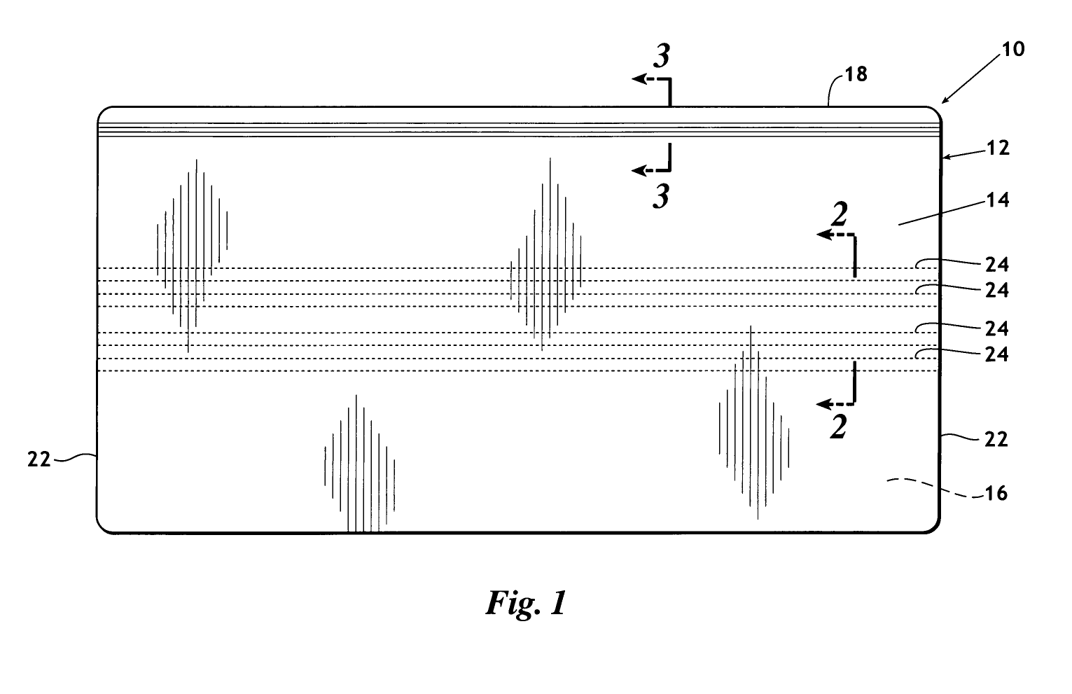

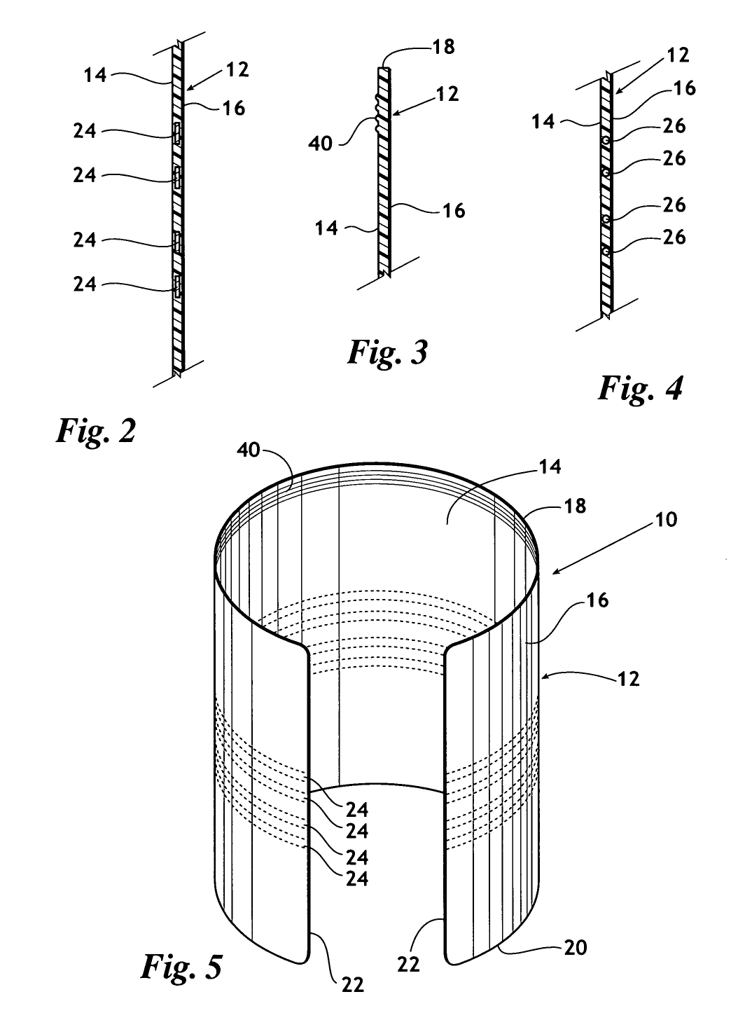

As illustrated in FIG. 1, an embodiment 10 of the present invention is shown and generally illustrates a device comprising a flat panel 12 constructed of a combination of material having sufficient flexibility for repeated coiling into a substantially cylindrical configuration while having sufficient elasticity for returning to its initial flat configuration. Panel 12 is of a generally flat rectangular configuration having a first surface 14, a second surface 16, a top edge 18, a bottom edge 20, and a pair of lateral edges 22. In this embodiment, two channels 24 are horizontally located across the panel 12. Memory retention units 26 are located within each channel 24. While this embodiment shows the memory retention units 26 being placed within the channels 24, it is within the scope of the invention that the memory retention units 26 be directly incorporated within panel 12 by other processes, such as, but not limited to, dual-lamination.

It is further understood by those skilled in the art that while the number of channels and memory retention units in this embodiment is two, this number is illustrative and not meant to be limiting. Panel 12 and memory retention units 26 are made from materials having sufficient elasticity, or memory of its original shape, to attempt to return to such original shape upon release.

By having the combination of the panel 12 and the memory retention units 26, the present invention is able to be repeatedly coiled in a substantially cylindrical configuration while returning to its initially flat configuration.

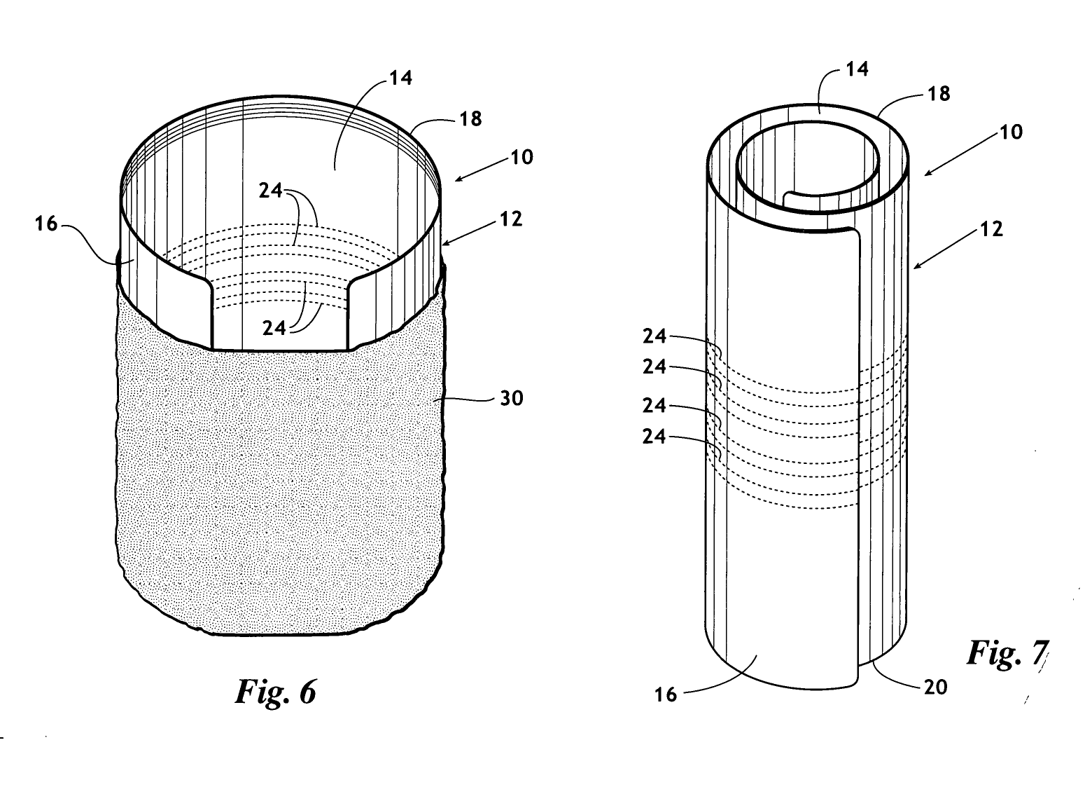

In operation, panel 12 is coiled into a substantially cylindrical configuration and placed into a flexible container 30, such as but not limited to a plastic trash bag, as shown in FIGS. 5 and 6. Upon release of panel 12, it expands in an attempt to return to its original flat configuration, engaging the flexible container 30 in the process, and thus, holding it open. A person is then able to fill the flexible container 30 with various items without the need of opening the flexible container 30 independently.

In an additional embodiment, as shown in FIG. 2, a series of gripping ridges 40 are located across the first surface 14 of panel 12. This allows the user to better grip panel 12 when removing the panel 12 from container 30.

The panel 12 is made from a material with is sufficiently resistant to damage from sharp object and weather conditions, while being sufficiently flexible to allow the coiling of panel 12. Such material can include a polymer or rubber. Memory retention units 26, likewise, are made from a material that is sufficiently flexible but elastic to allow repeated coiling and returning its initial configuration. One such material which might be used is spring steel. Those skilled in the art would recognize that this material is merely illustrative and is not meant to be limiting.

In this embodiment, as shown in FIG. 2, the memory retention units 26 have a rectangular cross-section. While it is illustrated that the cross-section of the memory retention units 26 are rectangular, other embodiments, the cross-section of the memory retention units 26 can be circular in nature, as shown in FIG. 4.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claims, including the full range of equivalency to which each element thereof is entitled.

1. A removable internal support for a flexible container having an open end comprising:
a panel of generally flat rectangular configuration having a first surface, a second surface, a top edge, a bottom edge, and a pair of lateral edges; and
at least one memory retention unit being imbedded in said panel.

2. The support of claim 1 wherein said panel is constructed from a first sufficiently flexible material.

3. The support of claim 2 wherein said sufficiently flexible material is a polymer.

4. The support of claim 2 wherein said sufficiently flexible material is a rubber material.

5. The support of claim 1 wherein said at least one memory retention units are made from a second sufficiently flexible material.

6. The support of claim 5 wherein said second sufficiently flexible material is spring steel.

7. The support of claim 1 wherein said panel is further defined as having at least one channel being formed therein and the number of said at least one memory retention unit being equal to the number of said at least one channel with each of said at least one memory retention units being located within said at least one channel.

8. The support of claim 7 wherein said at least one memory retention units are made from a second sufficiently flexible material.

9. The support of claim 8 wherein said second sufficiently flexible material is spring steel.

10. The support of claim 7 wherein each of said at least one channel extends along the entire horizontal length of said panel.

11. A removable internal support for a flexible container having an open end comprising:
a panel of generally flat rectangular configuration having a first surface, a second surface, a top edge, a bottom edge, and a pair of lateral edges, said panel being constructed from a first sufficiently flexible material, said panel further having at least one channel being formed therein; and
at least one memory retention unit made from a second sufficiently flexible material being imbedded in said panel, wherein the number of said at least one memory retention unit being equal to the number of said at least one channel.

12. The support of claim 11 wherein said sufficiently flexible material is a polymer.

13. The support of claim 11 wherein said second sufficiently flexible material is rubber.

14. The support of claim 11 wherein said at least one memory retention units are made from a second sufficiently flexible material.

15. The support of claim 14 wherein said second sufficiently flexible material is spring steel.

16. A removable internal support for a flexible container having an open end comprising:
a panel of generally flat rectangular configuration having a first surface, a second surface, a top edge, a bottom edge, and a pair of lateral edges, said panel being constructed from a flexible polymer material, said panel further having two channels being formed horizontally therein, said panel further having build-up material extending along each of said at least one channel such that each of said at least one channel is enclosed within said panel; and
two memory retention units made from a flexible spring steel material with both of said channels receiving one of said two memory retention units.

17. The support of claim 16 where each of said at least one memory retention unit has a rectangular cross-section.

18. The support of claim 16 where each of said at least one memory retention unit has a circular cross-section.

19. The support of claim 16 where each of said at least one memory retention unit extends horizontally along said panel.

20. The support of claim 16 further comprising a plurality of gripping ridges formed out of said panel proximate to said top edge of said panel.
